(19) United States
(12) Patent Application Publication
(10) Pub. No.: US 2006/0096324 A1
(43) Pub. Date: May 11, 2006

(54) Method of manufacturing an integrated optical waveguide

(76) Inventors: Pietro Montani, Milano (IT); Matteo Garavaglia, Magenta (IT); Fabio Fusari, Settimo Milanese (IT); Marta Mottura, Milano (IT)

Correspondence Address: HOGAN & HARTSON LLP, ONE TABOR CENTER, SUITE 1500, 1200 SEVENTEENTH ST, DENVER, CO, 80202, US

(21) Appl. No.: 11/267,826

(22) Filed: Nov. 3, 2005

(30) Foreign Application Priority Data
Nov. 11, 2004 (IT) RM 2004A000560

(51) Int. Cl. C03B 37/022

(52) U.S. Cl. 65/386

(57) ABSTRACT

A waveguide includes a substrate, lower cladding having a decreasing cross-section, and a core having an increasing cross-section. The lower cladding is formed on a substrate, and the waveguide core is formed on the lower cladding. The waveguide core includes a first tract of constant thickness and a second tract of varying thickness, and finally side and upper cladding of the waveguide is formed. In order to obtain a waveguide having a segment of varying thickness in an easy, controlled and adiabatic manner, two series of operations are carried out to form the lower cladding and the core. The first series includes forming a layer of material of constant thickness for the lower cladding, selectively removing the material of this layer to reduce the thickness thereof in a plurality of regions being at gradually varying mutual distances and planarizing by a chemical-mechanical treatment on the residual layer; the second series includes forming a layer of material of constant thickness for the core, selectively removing the material of this layer to reduce the thickness thereof in a plurality of regions being at gradually varying mutual distances and planarizing by a chemical-mechanical treatment on the residual layer.

### RELATED APPLICATION

The present application claims priority of Italian Patent Application No. RM2004A000560 filed Nov. 11, 2004, entitled MANUFACTURING PROCESS OF AN INTEGRATED OPTICAL WAVEGUIDE, which is incorporated herein in its entirety by this reference.

### FIELD OF THE INVENTION

The present invention relates to optical waveguides, and more particularly, to a manufacturing process for an integrated optical waveguide.

### BACKGROUND OF THE INVENTION

In the field of data communication and transmission, the current trend is to use optical signals in place of traditional electric signals.

The transmission of optical signals takes place through optical waveguides and the generation and processing of signals takes place by means of optical devices, such as laser sources, modulators, interferometers, and the like.

Devices of this type are currently manufactured mainly with planar technology in the form of integrated optical circuits, by using the manufacturing techniques typical of planar, semiconductor electronic circuits. According to one of these techniques, the waveguides are formed, together with other optical components, on a silicon or dielectric material substrate. A known manufacturing process of an integrated optical waveguide provides that three silicon dioxide doped layers are successively laid on a silicon substrate such that the first and third layer, which are called the lower cladding or buffer layer and the upper cladding layer, respectively, have substantially the same refraction index though lower than the refraction index of the intermediate state, which is called the core layer. This layer is subjected to conventional photolithographic techniques to obtain the cores of the waveguides forming one or more optical paths of the optical circuit designed. The cladding layers cover the cores from below, from above and from the sides. A light signal being input in a waveguide core is substantially embedded therein due to the phenomenon of total reflection caused by the difference of the refraction index of the cladding and that of the core. Each core with its proper cladding defines a waveguide having a substantially rectangular or square section, the height of which being defined by the thickness of the core, i.e. the distance between the lower cladding and the upper cladding. The section width is defined by the mask used in the photolithographic process of core definition.

A crucial aspect while designing optical systems is the coupling of different devices either within the same integrated optical circuit of outside thereof, for example coupling an integrated optical waveguide with an optical fiber. The waveguide ends to be coupled to each other may have different sections both in terms of shape and size. For example, in the case of cascade coupling between two optical devices, the end of the outlet waveguide of the first device may have a square section, whereas the end of the input waveguide of the second device may have a rectangular section of greater size, or an output waveguide from a device that is to be interfaced with an optical fiber can have a square section of relatively small area, whereas the end of the optical fiber may have a circular section of greater area. In these conditions, the coupling efficacy is generally very low.

To increase the coupling efficacy, techniques are known that allow one to change the end segments of either one or both waveguides to be coupled, by progressively increasing or decreasing the sections thereof in an adiabatic manner, i.e. minimizing the loss and maintaining only the propagation of the fundamental mode in the waveguide. The same techniques allow one to increase the section of a waveguide end segment in an adiabatic manner such that the latter can be coupled with an optical fiber having a greater section than that of the waveguide. The increase in the section can either involve both the height and the width of the section or only one of these dimensions.

In conventional manufacturing processes of an integrated optical circuit, the width of a waveguide section can be gradually and controllably changed in a relatively simple manner. Current photolithographic techniques, in fact, allow one to obtain cores having increasing or decreasing width by defining successive masks. As relates to the height of the waveguide, this is substantially defined when the core layer is laid down and is consistent along the whole area of the integrated optical device. The only variations, if any, in the height of the section, i.e. the thickness of the core, are due to uniformity defects that are inherent to the process applied.

Processes are also known that gradually change the height of the section of the end segment of a waveguide, i.e. progressively increasing the distance among the lower cladding and upper cladding layers. These processes are, however, somewhat complicated.

### SUMMARY OF THE INVENTION

The present invention provides a manufacturing process of an integrated optical waveguide that allows the thickness of a waveguide segment to be formed in an adiabatic and controlled manner. In the manufacturing process of the present invention, an integrated optical waveguide is formed on a substrate defined by a core and by upper, lower and side cladding. The lower cladding is formed on the substrate and the waveguide core is formed on the lower cladding. The core includes a first tract of constant thickness and a second tract of varying thickness joined to the first tract. The side and upper cladding are also formed. To obtain a waveguide having a segment of varying thickness in an easy, controlled and adiabatic manner, two series of operations are carried out to form the lower cladding and the core. The first series comprises forming a, layer of material of constant thickness for the lower cladding, selectively removing the material of this layer to reduce the thickness thereof in a plurality of regions at gradually varying mutual distances and planarizing by a chemical-mechanical treatment on the residual layer. The second series comprises forming a layer of material of constant thickness for the core, selectively removing the material of this layer to reduce the thickness thereof in a plurality of regions being at gradually varying mutual distances and planarizing by a chemical-mechanical treatment on the residual layer.

### BRIEF DESCRIPTION OF THE DRAWINGS

The invention is better understood from the detailed description below of a preferred embodiment thereof that is given by way of example with reference to the annexed drawings, in which the figures illustrate an end segment of an integrated optical waveguide in various steps of the manufacturing process according to the invention, in particular:

FIG. 1 is a longitudinal sectional view of a starting step of the manufacturing process according to the present invention;

FIGS. 2 to 9 are longitudinal sectional views of various intermediate steps of the process according to the present invention;

FIG. 10 is a longitudinal sectional view at the end of the process according to the present invention; and

FIG. 11 is an axonometric view of the structure shown in FIG. 10.

### DETAILED DESCRIPTION

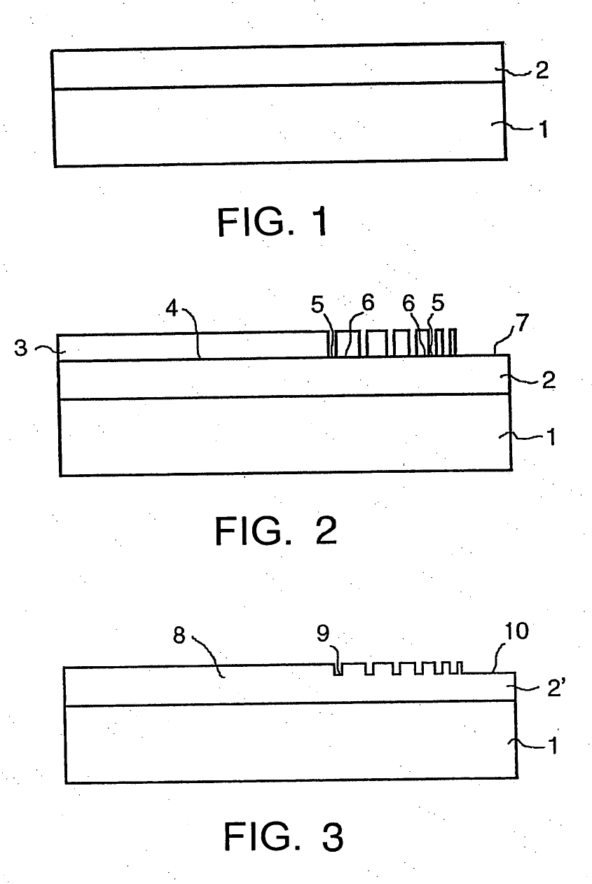

With reference to FIG. 1, the formation of an integrated optical device provides that a thick layer of silicon dioxide 2 of a substantially consistent thickness, which is intended to be the lower cladding, or buffer, of the waveguide, is laid on a silicon substrate 1.

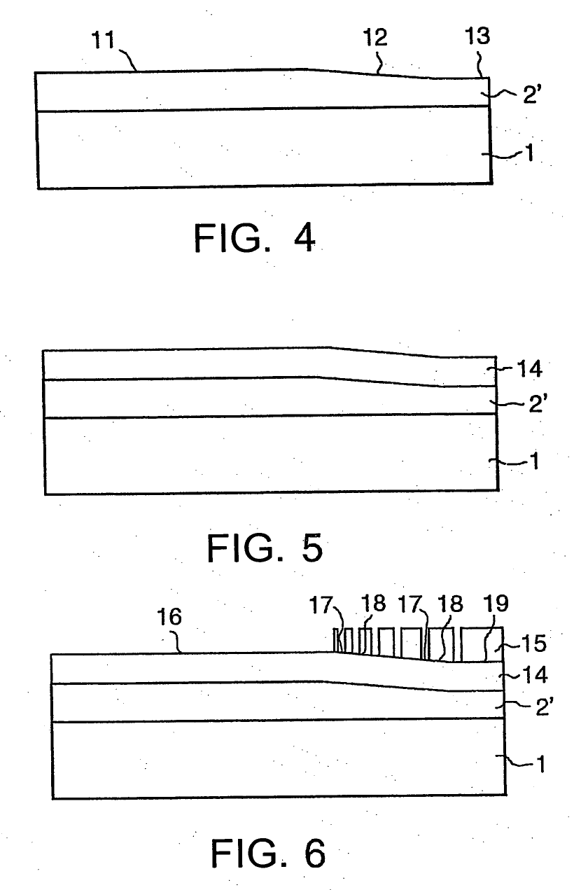

On the buffer layer, such as shown in FIG. 2, there is defined a photoresist mask 3 that, from left to right in the figure, covers an area 4 and leaves an area 7 and some areas 5 uncovered, which are substantially equal to each other, covered areas 6 being interposed therebetween that are progressively narrower. In a plan view, the areas 5 are strips all having the same length, preferably just greater than the width required for the core of the waveguide, and the area 7 has a width equal to the length of the stripes.

By anisotropic etching the material of the buffer layer unprotected by the mask 3 is removed to a preset depth. After the mask 3 has been also removed, a structure is obtained similar to that illustrated in FIG. 3. The residual buffer layer 2′ has, again from left to right: a tract 8 of constant height, a tract with recesses 9 of rectangular section of equal length, width and depth that are arranged at progressively decreasing distances from each other, and a final tract 10 of constant height and lower than the height of tract 8 and width equal to the length of the recesses 9.

The residual buffer layer 2′ is subjected to a chemical mechanical polishing treatment (CMP), after which the profile thereof is changed such as shown in FIG. 4. Now, the residual buffer layer has a tract 11 of constant height, a tract 12 of progressively decreasing height and a tract 13 again of constant height, though lower than tract 11.

Such as shown in FIG. 5 and 6, on the residual buffer layer 2′ there is laid a silicon dioxide layer 14 for the core, a photoresist mask 15 being subsequently defined thereon. This mask leaves uncovered, from left to right: an area 16 of the core layer, some areas 17 of the core layer of the same width with covered areas 18 being interposed therebetween and progressively wider. A further area 19 of the core layer is protected by the mask. In a plan view, the areas 17 are strips all having the same length, preferably just greater than the width required for the waveguide core, and the area 16 has a width equal to the length of the stripes.

After an anisotropic etching of the areas in the core layer that are unprotected by the mask and a step of removing the photoresist mask, a structure is obtained such as illustrated in FIG. 7. The residual core layer 14′ has a constant height along a tract 20 and then it has a sequence of ribs 21 arranged substantially at the same distance from each other and the width of the same gradually increases from left to right. The end tract 22 has a constant height and greater than that of tract 20.

A planarization step is then performed (CMP), such as that carried out above to level the residual core layer 14′ and obtain a structure such as that illustrated in FIG. 8. The residual core layer 14′ has, along a tract 23 thereof, a constant height, along a second tract 24 a gradually increasing height, and along a third tract 25 a constant height and greater than that of tract 23.

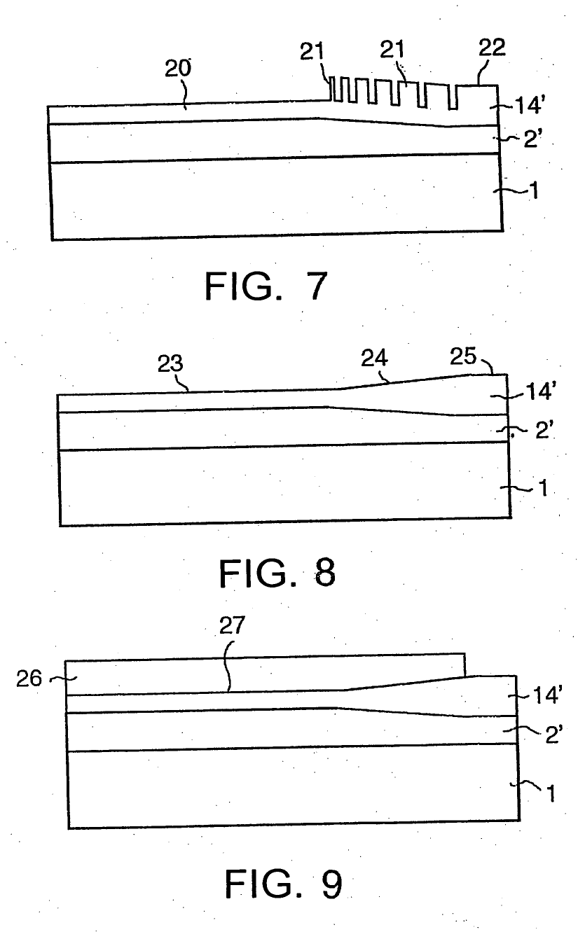

The process then provides laying a masking layer, defining a mask 26 and an anisotropic etching to define the width and length of the cores of the waveguides that constitute the path of the designed optical circuit. In FIG. 9 shows how the mask 26 protects a part of the layer 14′ intended to build the core of a waveguide end segment from the anisotropic etching and FIG. 10 shows how, after the anisotropic etching, the core comprises, from left to right, a segment 29 of constant thickness and an end segment 30 with a thickness progressively increasing towards the input/output end, being designated with 31, of the waveguide end segment. In this example, the growth is symmetrical relative to the horizontal plane passing through the core midline. As the final operation in the process, an upper and side cladding layer 28 is laid, such as shown in FIG. 10.

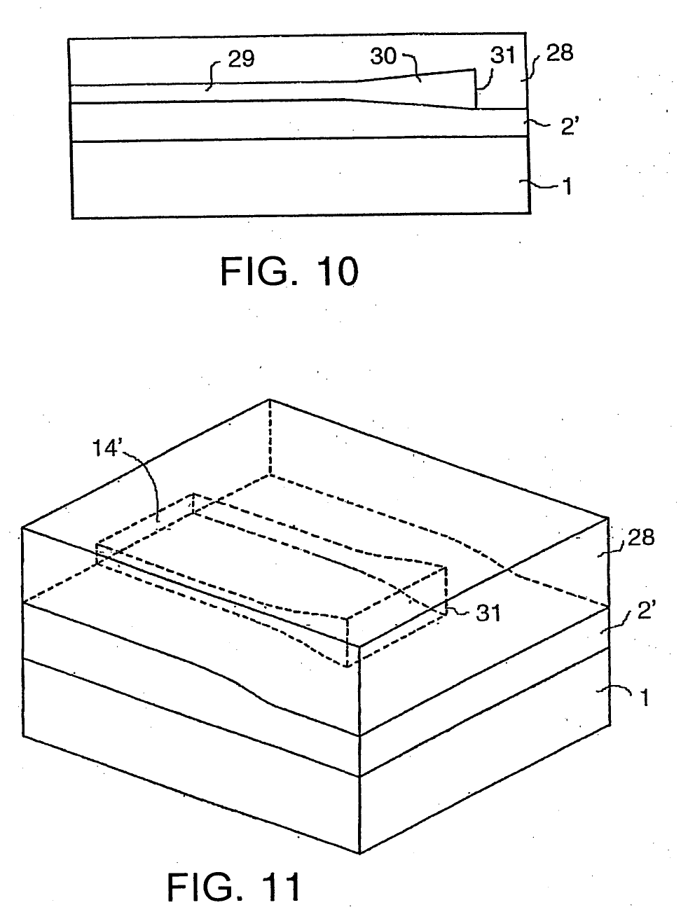

FIG. 11 shows the end segment of the integrated optical waveguide in an axonometric view in which the core can be seen in phantom. According to the present invention, the thickness of the waveguide core, in the end segment, can be adjusted such as to be gradually and adiabatically increased. This increase can be easily controlled by means of suitable configurations of the masks used in the process. While only one embodiment of the invention has been illustrated and described herein, it is understood that a number of variations can be carried out within the same inventive concept. For example, by eliminating the intermediate steps of defining the ribs of the core (FIGS. 6 and 7) and the subsequent planarization (FIG. 8) a waveguide is obtained with a thickness increasing only towards the lower cladding layer. By eliminating instead the intermediate steps of defining recesses in the buffer layers (FIGS. 2 and 3) and the subsequent planarization (FIG. 4) a waveguide is obtained with a thickness increasing only towards the upper cladding layer. Besides the variation in the thickness, a variation in the width of the waveguide core can be also obtained, by adding the operations provided to the purpose by the prior art to the process according to the invention. Furthermore, the process as described can be used not only to increase or decrease the thickness of a waveguide in an end segment thereof but also in any intermediate segment thereof.

While there have been described above the principles of the present invention in conjunction with specific memory architectures and methods of operation, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

We claim:

1. A manufacturing process for an integrated optical waveguide comprising:
forming a lower cladding of the waveguide on a substrate by forming a layer of material of substantially constant thickness for the lower cladding of the waveguide, selectively removing the material of the layer to decrease the thickness at a plurality of regions that gradually vary from an end region, and planarizing with a chemical-mechanical treatment of a residual layer after said selective removal;
forming a core of the waveguide on the lower cladding including a first tract of constant thickness and a second tract of varying thickness by forming a layer of a substantially, constant thickness for the waveguide core, selectively removing the material of the layer to reduce the thickness at a plurality of regions that gradually vary from an end region, and planarizing with a chemical-mechanical treatment of a residual layer after said selective removal; and
forming a side and an upper cladding of the waveguide.

2. The manufacturing process according to claim 1, further comprising decreasing a,cross-section of the lower cladding towards an input/output end of the waveguide.

3. The manufacturing process according to claim 1, further comprising increasing a cross-section of the core towards an input/output end of the waveguide.

4. The manufacturing process according to claim 1, further comprising forming the lower cladding, the core and the side and upper cladding of silicon dioxide.

5. A manufacturing process for an integrated optical waveguide comprising:
forming a lower cladding of the waveguide on a substrate;
forming a core of the waveguide on the lower cladding including a first tract of constant thickness and a second tract of varying thickness by forming a layer of a substantially constant thickness for the waveguide core, selectively removing the material of the layer to reduce the thickness at a plurality of regions that gradually vary from an end region, and planarizing with a chemical-mechanical treatment of a residual layer after said selective removal; and
forming a side and an upper cladding of the waveguide.

6. The manufacturing process according to claim 5, further comprising decreasing a cross-section of the lower cladding towards an input/output end of the waveguide.

7. The manufacturing process according to claim 5, further comprising increasing a cross-section of the core towards an input/output end of the waveguide.

8. The manufacturing process according to claim 5, further comprising forming the lower cladding, the core and the side and upper cladding of silicon dioxide.

9. A manufacturing process for an integrated optical waveguide comprising:
forming a lower cladding of the waveguide on a substrate by forming a layer of material of substantially constant thickness for the lower cladding of the waveguide, selectively removing the material of the layer to decrease the thickness at a plurality of regions that gradually vary from an end region, and planarizing with a chemical-mechanical treatment of a residual layer after said selective removal;
forming a core of the waveguide on the lower cladding including a first tract of constant thickness and a second tract of varying thickness; and
forming a side and an upper cladding of the waveguide.

10. The manufacturing process according to claim 9, further comprising decreasing a cross-section of the lower cladding towards an input/output end of the waveguide.

11. The manufacturing process according to claim 10, further comprising increasing a cross-section of the core towards an input/output end of the waveguide.

12. The manufacturing process according to claim 10, further comprising forming the lower cladding, the core and the side and upper cladding of silicon dioxide.
